(19) United States
(12) Patent Application Publication
(10) Pub. No.: US 2011/0164571 A1
(43) Pub. Date: Jul. 7, 2011

(54) METHOD FOR ESTABLISHING OF A POINT-TO-POINT CONNECTION BETWEEN A MOBILE NODE AND A NETWORK ENTITY, A CORRESPONDING MOBILE NODE AND A CORRESPONDING NETWORK ENTITY

(75) Inventors: Changpeng Fan, Berlin (DE); Carmelita Görg, Bremen (DE); Umer Iqbal, Bremen (DE); Umar Toseef, Bremen (DE); Asanga Udugama, Bremen (DE)

(73) Assignee: NOKIA SIEMENS NETWORKS GMBH & CO. KG, Munich (DE)

(21) Appl. No.: 13/062,978

(22) PCT Filed: Sep. 10, 2008
(86) PCT No.: PCT/EP2008/062000

§ 371 Date: Mar. 9, 2011

(51) Int. Cl. H04W 8/08; H04W 4/00

(52) U.S. Cl. 370/328

(57) ABSTRACT

The present invention refers to establishing of a point-to-point connection between a mobile node and a network entity by use of an access link of the network entity, wherein the network entity is configured to manage mobility related signalling for mobile nodes attached to the access link of the network entity. According to the present invention, the mobile node is attached to the access link of the network entity. Further, a router advertisement message is transmitted from the network entity to the mobile node, wherein the router advertisement message comprises a home network prefix and a mobile node identifier. Then, a home address of the mobile node is configured from the home network prefix by the mobile node, if the node identifier represents a node identifier of the mobile node.

### FIELD OF THE INVENTION

The present invention relates to establishing of a point-to-point connection between a mobile node and a network entity by use of an access link of said network entity, wherein said network entity is configured to manage mobility related signalling for mobile nodes attached to said access link of said network entity. In particular, the present invention relates to a method for said establishing of a point-to-point connection between a mobile node and a network entity, a correspondingly configured mobile node, a correspondingly configured network entity, and a router advertisement message being configured to be used for said establishing of a point-to-point connection between a mobile node and a network entity.

### BACKGROUND OF THE INVENTION

With rapid development of communications technologies and with the advent of new wireless and cellular technologies, demands with regard to more and more services to be provided in communications networks over wireless links have been arisen. Advantages arising by having wireless connectivity have convinced many users. Thus, the amount of users utilizing mobile devices (e.g., cost effective handheld devices) has also increased tremendously.

Coping with the continuing increase of amount of users and keeping of providing of satisfactory services to these users at the same time have become one of the biggest challenges for (communications) service providing companies.

In particular, mobility management or mobility related functionality, respectively, belongs to one of the challenging areas. Mobility management is one of the major functions in communications networks, which allows mobile devices or mobile nodes, respectively, to work. The aim of the mobility management is to track or to be aware of where the users of the communications network are, so that mobility services like calls or short message service (SMS), for example, can be provided to these users.

When performing mobility management, additional use of air interface traffic required for mobility management signalling. Further, an increasing number of users has to be handled at the same time by the mobility management. When considering conventional solutions for mobility management, here is still a need for new mobility management methodologies allowing both reducing of the air interface traffic and handling of many users in an effective way at the same time.

### SUMMARY OF THE INVENTION

Object of the present invention is to provide an improved mobility management of mobile nodes in a communications network.

This object is achieved by a method for establishing of a point-to-point connection between a mobile node and a network entity comprising features according to claim 1, a corresponding mobile node comprising features according to claim 14, a corresponding network entity comprising features according to claim 23, and/or a router advertisement message comprising features according to claim 33.

Further embodiments of the present invention are provided with the corresponding dependent claims.

The object of the present invention is achieved by a method for establishing of a point-to-point connection between a mobile node and a network entity by use of an access link of said network entity, wherein said network entity is configured to manage mobility related signalling for mobile nodes attached to said access link of said network entity, and wherein said method comprises:
attaching of said mobile node to said access link of said network entity;
transmitting of a router advertisement message from said network entity to said mobile node, wherein said router advertisement message comprises a home network prefix and a mobile node identifier; and
configuring of a home address of said mobile node from said home network prefix by said mobile node, if said node identifier represents a node identifier of said mobile node.

According to the present invention, the mobility related functionality is moved from the mobile node to a network entity, which is configured to manage mobility related signalling for mobile nodes. Thus, it is not required that a mobile node is involved in the signalling for mobility management.

Furthermore, according to the present invention, several mobile nodes can be attached to the access link of the network entity and the network entity can perform mobility management of several mobile nodes without requiring complex schemes when handling more than one mobile node.

In this way, the present invention allowing both reducing of the air interface traffic and handling of many users in an effective way at the same time.

According to the present invention, the home address is used to manage mobility related signalling of the mobile node.

Further, according to an embodiment of the present invention, the method comprises allocating of said home network prefix by a home agent of said mobile node or by a mobility anchor of said mobile node, respectively.

The mobility anchor of the mobile node is a home agent of the mobile node in a communications network or in a domain of a communications network, where the mobility management of the mobile node is handled.

According to an embodiment of the present invention, the method comprises transmitting of the home network prefix from the mobility anchor or home agent, respectively, to the network entity.

According to an embodiment of the present invention, the method comprises a binding of said network entity to said mobility anchor of said mobile node, wherein said binding comprises the allocating of said home network prefix.

According to an embodiment of the present invention, the binding comprises:
transmitting of a binding registration request message from said network entity to said mobility anchor of said mobile node; and
transmitting of a registration reply message from said mobility anchor to said network entity, wherein said registration reply message comprises said home network prefix.

According to an embodiment of the present invention, the binding comprises setting up of a tunnel between the mobility anchor and the network entity. Here the tunnel can be a bidirectional tunnel.

According to an embodiment of the present invention, the method comprises a determining of said home network prefix by the network entity.

According to an embodiment of the present invention, the determining of said home network prefix comprises a searching of said home network prefix in a database, in which said home network prefix and said mobile node identifier are associated.

According to an embodiment of the present invention, the method comprises transmitting of said mobile node identifier from said mobile node to the network entity after attaching of the mobile node to the access link of the network entity.

According to an embodiment of the present invention, the network entity represents a local mobility anchor.

According to an embodiment of the present invention, the mobile node identifier represents a network access identifier.

According to an embodiment of the present invention, the mobility anchor represents a local mobility anchor.

The object of the present invention is achieved by a mobile node being configured to establish a point-to-point connection to a network entity by use of an access link of said network entity, said network entity being configured to manage mobility related signalling for mobile nodes attached to said access link of said network entity, said mobile node comprising:
a module configured for attaching to said access link of said network entity;
a module configured for receiving of a router advertisement message from said network entity, wherein said router advertisement message comprises a home network prefix and a mobile node identifier; and
a module configured for configuring of a home address of said mobile node from said home network prefix, if said node identifier represents a node identifier of said mobile node.

According to the present invention, the home address is used to manage mobility related signalling of the mobile node.

According to an embodiment of the present invention, the mobile node comprises a module configured for transmitting of the mobile node identifier to the network entity after attaching to said network entity.

According to an embodiment of the present invention, the home network prefix is allocated by a home agent of the mobile node or by a mobility anchor of the mobile node, respectively.

According to an embodiment of the present invention, the mobility anchor, i.e., home agent of the mobile node is bound to the network entity, and the network entity is configured for receiving of the home network prefix from the mobility anchor or the home agent, respectively.

According to a further embodiment of the present invention, the home network prefix is determined by the network entity.

According to an embodiment of the present invention, the network entity is a mobile access gateway.

According to an embodiment of the present invention, the mobile node identifier is a network access identifier.

According to an embodiment of the present invention, the mobility anchor is a local mobility anchor.

Further, the object of the present invention is achieved by a network entity for establishing of a point-to-point connection to a mobile node by use of an access link of said network entity, wherein said network entity is configured to manage mobility related signalling for mobile nodes attached to said access link of said network entity, and wherein said network entity comprises:
a module configured for attaching of said mobile node to said access link;
a module configured for transmitting of a router advertisement message to said mobile node, wherein said router advertisement message comprises a home network prefix and a mobile node identifier; and
a module configured for managing mobility related signalling of said mobile node by use of a home address of said mobile node, wherein said home address is configured by said mobile node by use of said home network prefix if said mobile node identifier represents a mobile node identifier of said mobile node.

According to an embodiment of the present invention, the home network prefix is allocated at a mobility anchor of the mobile node or at a home agent of the mobile node, respectively.

According to an embodiment of the present invention, the network entity is bound to the mobility anchor of the mobile node or the home agent of the mobile node, respectively, and the network entity comprises a module configured for receiving of the home network prefix from the mobility anchor or the home agent, respectively.

According to an embodiment of the present invention, the network entity comprises:
a module configured for transmitting of a binding registration request message to said mobility anchor, i.e., home agent of said mobile node; and
a module configured for receiving of a registration reply message from said mobility anchor, i.e., home agent of said mobile node, wherein said registration reply message comprises said home network prefix.

According to an embodiment of the present invention, the network entity comprises a module for setting up a tunnel to said mobility anchor, i.e., home agent of said mobile node. Here, the tunnel can be a bidirectional tunnel.

According to an embodiment of the present invention, the network entity comprises a module for determining of the home network prefix.

According to an embodiment of the present invention, said module for determining of the home network prefix is configured for searching of the home network prefix in a database, in which the home network prefix and the mobile node identifier are associated.

According to an embodiment of the present invention, the network entity comprises a module configured for receiving of said mobile node identifier from the mobile node after the attaching.

According to an embodiment of the present invention, the network entity is a mobile access gateway.

According to an embodiment of the present invention, the mobile node identifier is a network access identifier.

According to an embodiment of the present invention, the mobility anchor, i.e., the home agent is a local mobility anchor.

Further, the object of the present invention is achieved by a router advertisement message, wherein:
said router advertisement message comprises a home network prefix and a mobile node identifier and
said router advertisement message is configured to be used for establishing of a point-to-point connection between a mobile node and a network entity by performing of the method sketched above and described in more detail below.

By use of the present invention, it is not required that a mobile node is involved in the signalling for mobility management. Here, the mobility related functionality is moved from the mobile node to a network entity referred to as mobile access gateway (MAG), which is configured to perform all mobility related functionality on behalf of the mobile node. In this way, e.g., battery usage and processing overhead at the mobile node are reduced. Further, air interface traffic is reduced and available bandwidth is increased, as no periodic binding messages are exchanged between mobile nodes and mobility anchors or home agents, respectively, and as the traffic between mobile nodes and mobility anchors or home agents, respectively, is not a tunneled traffic.

Further, the present invention allows a generic sharing of an access link between several mobile nodes, which can be used in general in several communications networks and which can be implemented in an easy way without requirements of complex schemes or conditions for sharing of an access link, here, the access link of the mobile node, which is responsible for mobility management of mobile nodes.

Consequently, the present invention provides a solution of mobility management, which can help service providing companies to perform better in the market.

### BRIEF DESCRIPTION OF THE DRAWINGS

The present invention will be more clearly understood from the following description of the preferred embodiments of the invention read in conjunction with the attached drawings, in which:

FIG. 1 presents an implementation of the present invention according to an embodiment of the present invention;

FIG. 2 presents an implementation of the present invention according to a further embodiment of the present invention; and

FIGS. 3a and 3b present a configuration of a router advertisement message according to an embodiment of the present invention.

### DESCRIPTION OF THE PREFERRED EMBODIMENTS

In following, the present invention will be described by use of terms of mobility management protocol Proxy Mobile IPv6 (PMIPv6). However, the use of these terms should not be seen as limiting the present invention with regard to PMIPv6. The present invention can be implemented with regard also to further mobility management protocols or environments.

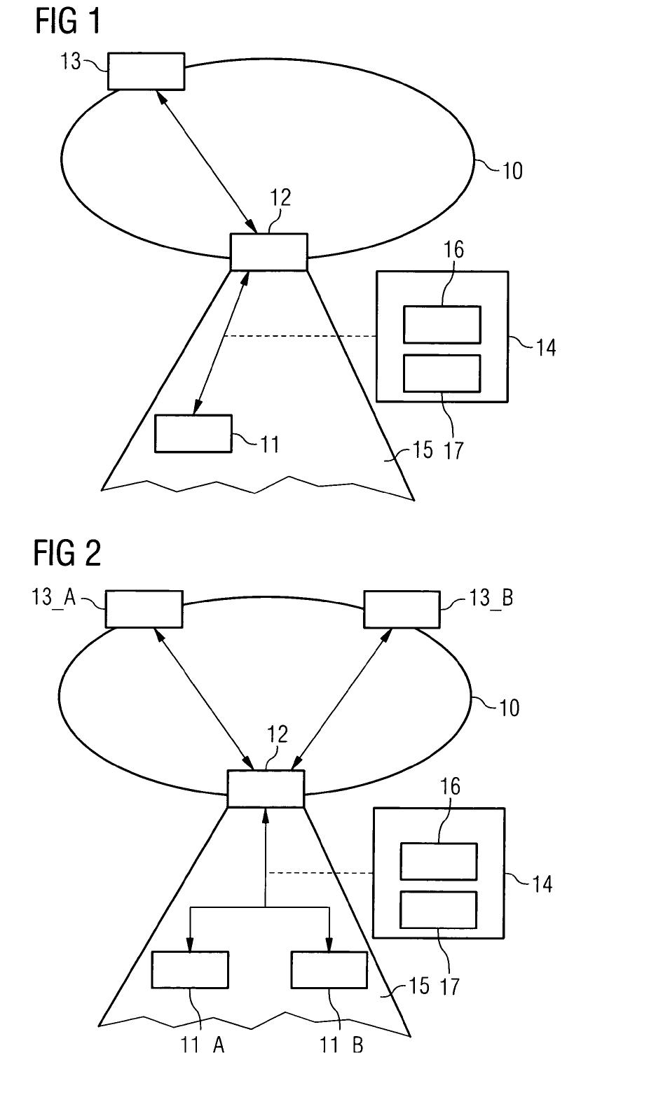

FIG. 1 presents an implementation of the present invention according to an embodiment of the present invention.

Here, a network entity 12 handles mobility on behalf on a mobile node 11 and will be referred to in following as mobile access gateway (MAG). The MAG 12 is configured to monitor the presence and movement of mobile nodes in its access link 15. Further, the network entity or MAG 12, respectively, is configured to indicate the monitored presence and movement of the mobile node 11 to a mobility anchor or a home agent 13 of the mobile node 11. In following, this home agent 13 is referred to as local mobility anchor (LMA). The MAG 12 and the LMA 13 are provided in a PMIPv6 domain 10, said PMIPv6 domain 10 being a communications domain for managing mobility of mobile nodes.

When the mobile node 11 connects to the MAG 12, the mobile node 11 is attached to the access link 15 of the MAG 12, the MAG 12 performs necessary authentication and binding procedures with the LMA 13 before starting data transfer to and from the mobile node 11. The LMA 13 represents a topological anchor point for the home network prefix 16 of the mobile node 11 and manages the binding state of the mobile node 11.

When the mobile node 11 is attached to the access link 15 of the MAG 12 in the PMIPv6 domain 10, the MAG 12 transmits a router advertisement to the mobile node 11. In router advertisements 14, which the mobile node 11 receives from the MAG 12, a home network prefix (HNP) 16 is always comprised and provided. This HNP 16 is topologically anchored at the local mobility anchor of the mobile node 11, the LMA 13.

Here, it has to be noted, that the home network prefix (HNP) 16 can be determined by the MAG 12 or by the LMA 13.

If the HNP 16 is determined by the LMA 13, the LMA 13 allocates a home network prefix (HNP) 16 and transmits this HNP 16 to the MAG 12, when the binding between the LMA 13 and the MAG 12 is performed.

If the HNP 16 is determined by the MAG 12, the MAG 12 is configured to search for the HNP 16 in a database, where an identifier 17 of the mobile node 11 like Mobile Node-Network Access Identifier (NM-NAI) and the HNP 16 are associated. In particular, the identifier 17 indicates the identity of the mobile node 11 in the PMIPv6 domain 10. Then, the MAG 12 provides the HNP 16, which is associated with the NM-NAI 17 of the mobile node 11.

In following, the present invention will be explained exemplary by considering the determining of the HNP 16 by the LMA 13.

The mobile node 11 configures its interface with an address (Mobile Node's Home Address (MN-HoA)) from this home network prefix 16 or by use of this home network prefix 16, respectively. If the mobile node 11 connects to the PMIPv6 domain 10 through multiple interfaces, simultaneously, each of the connected interfaces will be assigned a unique HNP and under a different mobility session.

The home address or MN-HoA, respectively, to be configured by the mobile node 11 is an address from the home network prefix 16 of the mobile node 11 in the PMIPv6 domain 10. The mobile node 11 uses this address as long as it is attached to the access network that is in the scope of that PMIPv6 domain 10.

Further, according to the present invention, the router advertisements 14 comprise also identifiers 17 of mobile nodes 11 like Mobile Node-Network Access Identifiers (NM-NAI). The identifier 17 comprised in the router advertisement 14 indicates the identity of the mobile node 11 in the PMIPv6 domain 10.

The LMA 13 is responsible for maintaining the reachability state of the mobile node 11 and is the topological anchor point for the home network prefix 16 of the mobile node 11. The MAG 12 is a network entity, which performs the mobility management on behalf of a mobile node resides on the access link 15, where the mobile node 11 is anchored. The MAG 12 is responsible for detecting the movements of the mobile node 11 to and from the access link 15 and for initiating binding registrations to the local mobility anchor of the mobile node.

In following, steps to be performed for establishing of a connection between the mobile node 11 and the MAG 12 for mobility management will be described exemplary in more detail.

First, when, the mobile node 11 enters PMIPv6 domain 10, it attaches to access link 15 of MAG 12 for mobility management purpose. Further, the mobile node 11 passes its identifier, here, a mobile node network access identifier (MN-NAI), to MAG 12 as a part of its authentication procedure.

Then, the MAG 12 on the access link 15 identifies the mobile node 11 and acquires the identity of the mobile node 11. Further, MAG 12 determines whether the mobile node 11 is authorized for the network-based mobility management service. The MAG 12 checks policy profile of the mobile node by use of the MN-NAI and, if the mobile node is eligible to be serviced at the access link 15 of the MAG 12, a binding of the MAG 12 and the LMA 13 is performed.

In this binding, the MAG 12 sends a proxy binding update (PBU) message to the LMA 13 or the mobile node 11. The MAG 12 gets information about LMA 13 of the mobile node 11 from the policy profile of the mobile node 11.

Then, the LMA 13 receives the PBU, allocates a home network prefix or HNP 16, respectively, for the mobile node. The allocated HNP 16 will be reserved permanently for the mobile node 11. Then, LMA 13 creates a binding cache entry (BCE), sets up tunnel end point with the local mobility anchor's address (LMMA) and proxy care of address (PCoA), wherein PCoA is the egress address of the MAG 12. Further, the LMA 13 sends a proxy binding acknowledgement (PBA) to the MAG 12.

In a next step, the MAG 12 receives the PBA, creates a binding update list entry (BULE) and sets up a tunnel end point between PCoA and LMAA. After that, a bidirectional tunnel is created between the LMA 13 and the MAG 12.

Then, the MAG 12 transmits a router advertisement 14 to the mobile node 11, wherein the router advertisement 14 comprises the home network prefix or HNP 16, respectively, and the identifier of the mobile node 11, the MN-NAI 17.

The mobile node 11 receives the router advertisement message 14 and checks whether the MN-NAI 17 comprised in the router advertisement message 14 actually represents the MN-NAI of the mobile node 11. If so, the mobile node configures its home address or NM-HoA, respectively, from the home network prefix 16. As already mentioned above, the NM-HoA is configured for the interface of the mobile node 11 to the MAG 12 and, thus, to the domain 10 responsible for mobility management of the mobile node 11.

Some of the steps provided above have some intersections with the PMIPv6, which also provides a MAG, which is configured to perform all mobility related functionality on behalf of the mobile node.

However, when using the methodology according to PMIPv6, problems arise when several mobile nodes try to connect to the same MAG and the same access link is used. According to PMIPv6, the connection between a mobile node and a MAG is always a point-to-point connection, thus a sharing of an access link does not represent the main concept of the PMIPv6. Further, in PMIPv6, a per-MN prefix model is used, according to which a prefix is permanently reserved for a certain MN only. A sharing of a prefix between two mobile nodes is not allowed in general according to PMIPv6.

In PMIPv6, a shared prefix model can be used with a stateful address configuration method only. The mobile node is not allowed to use any of the stateless auto configuration techniques.

Thus, according to PMIPv6, mobile nodes using stateless address configuration can not share the same access link. In particular, in case of non 3GPP providers like internet service providers (ISP), for example, the methodology of PMIPv6 will not be applicable, as the ISPs require that mobile nodes connecting to a communications network share the access link.

The present invention provides the advantage of sharing of the access link 15 between several mobile nodes without requiring special models or configuration methods like PMIPv6.

FIG. 2 presents an implementation of the present invention according to an embodiment of the present invention. In particular, a sharing of the access link 15 of the MAG 12 between two mobile nodes 11_A and 11_B according to the present invention is visualised by the FIG. 2.

In FIG. 2, the mobile node 11_A connects to a MAG 12 by attaching to the access link 15. The MAG 12 performs a binding with a mobility anchor or a home agent 13_A of the mobile node 11_A in the PMIPv6 domain 10, respectively. Thus, a binding with a corresponding LMA 13_A is performed. In particular, a bidirectional tunnel is created between the MAG 12 and the LMA 13_A, and the LMA 13_A of the mobile node 11_A allocates a home network prefix (HNP) for the mobile node 11_A and transmits this HNP to the MAG 12.

Further, according to FIG. 2, also a mobile node 11_B connects to a MAG 12 by attaching to the access link 15. The MAG 12 performs a binding with a home agent or mobile anchor 13_B of the mobile node 11_B in the PMIPv6 domain 10, thus, with the corresponding LMA, respectively. In particular, a bidirectional tunnel is created between the MAG 12 and the LMA 13_B, and the LMA 13_B of the mobile node 11_B allocates a HNP for the mobile node 11_B and transmits this HNP to the MAG 12.

Here, it has to be noted, that the HNP can be determined alternatively also by the MAG 12, as already pointed out above.

When a mobile node 11_A, 11_B is attached to the access link 15 of the MAG 12, the MAG 12 sends a corresponding router advertisement 14 to mobile nodes 11_A, 11_B attached to the access link 15. In particular, the MAG 12 sends router advertisements 14 to mobile nodes 11_A and 11_B by use of the common link 15, wherein each router advertisements 14 comprise a HNP 16 allocated, e.g., by one of the corresponding LMAs 13_A and 13_B and the corresponding identifier (MN-NAI) 17 of the corresponding mobile node 11_A, 11_B.

A first router advertisement 14 transmitted at first by the MAG 12 with a corresponding HNP 16 can be a multicast message; and once the MAG 12 comes to know or finds out the real address of the corresponding mobile node 11_A, 11_B, e.g., by other means like data presented on the tunnel, for example, the MAG 12 can transmit unicast router advertisements 14 comprising the corresponding HNP 16.

If the mobile node 11_A receives a router advertisement message 14, it checks whether the MN-NAI 17 comprised in the router advertisement message 14 actually represents the MN-NAI of the mobile node 11. If so, the mobile node configures its home address or MN-HoA, respectively, from the home network prefix 16. Otherwise, the mobile node 11_A will ignore or discard the router advertisement message 14 and will wait for a next router advertisement message 14.

The mobile node 11_B behaves in the same way, when it receives a router advertisement message 14, it checks the MN-NAI 17 comprised in the router advertisement message 14. If the MN-NAI 17 corresponds to the MN_NAI of the mobile node 11_B, the mobile node 11_B will configure the NM-HoA with regard to the MAG 12 and, thus, to the domain 10 responsible for mobility management of the mobile node 11.

In this way, the present invention enables a generic way of sharing of the access link 15 between several mobile nodes without requiring special models or configuration methods, which is applicable with regard to several communications environments and components.

Thus, according to the present invention, also mobile nodes using stateless address configuration can share the same access link. In this way, 3GPP providers like internet service providers (ISP), for example, will be to use the mobility management according to the present invention.

Consequently, the present invention is applicable to all mobility management protocols, which require a point-to-point connectivity between the nodes of a communications network and which require of prefer a sharing of access links between different nodes.

Further, to avoid processing overheads arising by checking of the identifiers comprised in the router advertisements, the methodology presented above can be devised so than a mobile node, after configuration of the home address, does not process each router advertisement sent by the MAG.

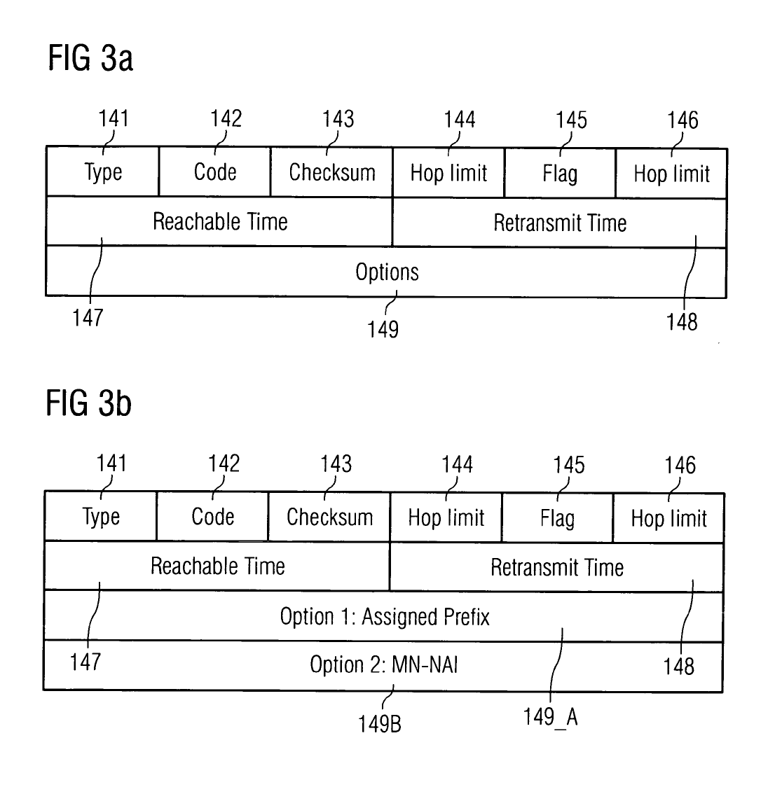

In FIGS. 3a and 3b, a configuration of a router advertisement message 14 according to an embodiment of the present invention is presented.

In particular, FIG. 3a shows a general configuration of a header of a router advertisement message 14 according to an embodiment. Here, fields like “Type” 141, “Code” 142, “Checksum” 143, “Hop limit” 144, 146, “Flag” 145, “Reachable Time” 147, “Retransmit Time” 148, or “Options” 149 can be provided.

In FIG. 3b, the header of the router advertisement message is configured to comprise a home network prefix (HNP) 149_A of a mobile node, and a node identifier (MN-NAI) 149_B of the mobile node, both being provided in the option part 149 of the router advertisement message 14.

Thus, the present invention refers to establishing of a point-to-point connection between a mobile node and a network entity by use of an access link of the network entity, wherein the network entity is configured to manage mobility related signalling for mobile nodes attached to the access link of the network entity. According to the present invention, the mobile node is attached to the access link of the network entity. Further, a router advertisement message is transmitted from the network entity to the mobile node, wherein the router advertisement message comprises a home network prefix and a mobile node identifier. Then, a home address of the mobile node is configured from the home network prefix by the mobile node, if the node identifier represents a node identifier of the mobile node.

While embodiments and applications of this invention have been shown and described above, it should be apparent to those skilled in the art, that many more modifications (than mentioned above) are possible without departing from the inventive concept described herein. The invention, therefore, is not restricted except in the spirit of the appending claims. It is therefore intended that the foregoing detailed description is to be regarded as illustrative rather than limiting and that it is understood that it is the following claims including all equivalents described in these claims that are intended to define the spirit and the scope of this invention. Nor is anything in the foregoing description intended to disavow the scope of the invention as claimed or any equivalents thereof.

### REFERENCE LIST

10 a mobility management domain
11 mobile node
11_A mobile node
11_B mobile node
12 network entity
13 a mobility anchor of a mobile node
13_A a mobility anchor of a mobile node
13_B a mobility anchor of a mobile node
14 a router advertisement message
15 access link of the network entity
16 a home network prefix
17 a mobile node identifier
141 “Type”-Field
142 “Code”-Field
143 “Checksum”-Field
144 “Hop limit”-Field
145 “Flag”-Field
146 “Hop limit”-Field
147 “Reachable Time”-Field
148 “Retransmit Time”-Field
149 “Options”-Field
149_A field comprising a home network prefix
149_B field comprising a mobile node identifier

1. A method for establishing of a point-to-point connection between a mobile node and a network entity by use of an access link of said network entity, wherein said network entity is configured to manage mobility related signalling for mobile nodes attached to said access link of said network entity, and wherein said method comprises:
attaching of said mobile node to said access link of said network entity;
transmitting of a router advertisement message from said network entity to said mobile node, wherein said router advertisement message comprises a home network prefix and a mobile node identifier; and
configuring of a home address of said mobile node from said home network prefix by said mobile node, if said node identifier represents a node identifier of said mobile node.

2. The method according to claim 1, wherein said home address is used to manage mobility related signalling of said mobile node.

3. The method according to claim 1, wherein said method comprises allocating of said home network prefix by a mobility anchor of said mobile node.

4. The method according to claim 3, wherein said method comprises transmitting of said home network prefix from said mobility anchor to said network entity.

5. The method according to claim 3, wherein said method comprises a binding of said network entity to said mobility anchor of said mobile node, wherein said binding comprises said allocating of said home network prefix.

6. The method according to claim 5, wherein said binding comprises:
transmitting of a binding registration request message from said network entity to said mobility anchor of said mobile node; and
transmitting of a registration reply message from said mobility anchor to said network entity, wherein said registration reply message comprises said home network prefix.

7. The method according to claim 5, wherein said binding comprises a setting up of a tunnel between said mobility anchor and said network entity.

8. The method according to claim 1, wherein said method comprises a determining of said home network prefix by said network entity.

9. The method according to claim 8, wherein said determining of said home network prefix comprises a searching of said home network prefix in a database, in which said home network prefix and said mobile node identifier are associated.

10. The method according to claim 1, wherein said method comprises transmitting of said mobile node identifier from said mobile node to said network entity after said attaching of said mobile node to said access link of said network entity.

11. The method according to claim 1, wherein said network entity represents a local mobility anchor.

12. The method according to claim 1, wherein said mobile node identifier represents a network access identifier.

13. The method according to claim 3, wherein said mobility anchor represents a local mobility anchor.

14. A mobile node being configured to establish a point-to-point connection to a network entity by use of an access link of said network entity, said network entity being configured to manage mobility related signalling for mobile nodes attached to said access link of said network entity, said mobile node comprising:
a module configured for attaching to said access link of said network entity;
a module configured for receiving of a router advertisement message from said network entity, wherein said router advertisement message comprises a home network prefix and a mobile node identifier; and
a module configured for configuring of a home address of said mobile node from said home network prefix, if said node identifier represents a node identifier of said mobile node.

15. The mobile node according to claim 14, wherein said home address is used to manage mobility related signalling of said mobile node.

16. The mobile node according to claim 14, wherein said mobile node comprises a module configured for transmitting of said mobile node identifier to said network entity after said attaching to said network entity.

17. The mobile node according to claim 14, wherein said home network prefix is allocated by a mobility anchor of said mobile node.

18. The mobile node according to claim 17, wherein said mobility anchor of said mobile node is bound to said network entity and wherein said network entity is configured for receiving of said home network prefix from said mobility anchor.

19. The mobile node according to at least one of the claim 14, wherein said home network prefix is determined by said network entity.

20. The mobile node according to claim 14, wherein said network entity is a mobile access gateway.

21. The mobile node according to claim 14, wherein said mobile node identifier is a network access identifier.

22. The mobile node according to claim 17, wherein said mobility anchor is a local mobility anchor.

23. A network entity for establishing of a point-to-point connection to a mobile node by use of an access link of said network entity, wherein said network entity is configured to manage mobility related signalling for mobile nodes attached to said access link of said network entity, and wherein said network entity comprises:
a module configured for attaching of said mobile node to said access link;
a module configured for transmitting of a router advertisement message to said mobile node, wherein said router advertisement message comprises a home network prefix and a mobile node identifier; and
a module configured for managing mobility related signalling of said mobile node by use of a home address of said mobile node, wherein said home address is configured by said mobile node by use of said home network prefix if said mobile node identifier represents a mobile node identifier of said mobile node.

24. The network entity according to claim 23, wherein said home network prefix is allocated at a mobility anchor of said mobile node.

25. The network entity according to claim 24, wherein said network entity is bound to said mobility anchor of said mobile node and wherein said network entity comprises a module configured for receiving of said home network prefix from said mobility anchor.

26. The network entity according to claim 24, said network entity comprising:
a module configured for transmitting of a binding registration request message to said mobility anchor of said mobile node; and
a module configured for receiving of a registration reply message from said mobility anchor of said mobile node, wherein said registration reply message comprises said home network prefix.

27. The network entity according to claim 24, said network entity comprising a module for setting up a tunnel to said mobility anchor of said mobile node.

28. The network entity according to claim 23, wherein said network entity comprises a module for determining of said home network prefix.

29. The network entity according to claim 28, wherein said module for determining of said home network prefix is configured for searching of said home network prefix in a database, in which said home network prefix and said mobile node identifier are associated.

30. The network entity according to claim 23, wherein said network entity comprises a module configured for receiving of said mobile node identifier from said mobile node after said attaching.

31. The network entity according to claim 23, wherein said network entity is a mobile access gateway.

32. The network entity according to claim 23, wherein said mobile node identifier is a network access identifier.

33. A router advertisement message, wherein:
said router advertisement message comprises a home network prefix and a mobile node identifier and
said router advertisement message is configured to be used for establishing of a point-to-point connection between a mobile node and a network entity by performing of a method according to claim 1.
